(19) United States
(12) Patent Application Publication
(10) Pub. No.: US 2010/0251164 A1
(43) Pub. Date: Sep. 30, 2010

(54) NAVIGATION AMONG MEDIA FILES IN PORTABLE COMMUNICATION DEVICES

(75) Inventors: Bilgi KARAN, Lund (SE); Joshua MURRAY, Malmo (SE); Benjamin FAGNOT, Malmo (SE); Klas TAUBERMAN, Arlov (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/413,840

(22) Filed: Mar. 30, 2009

(51) Int. Cl. G06F 3/048; G06F 17/30

(52) U.S. Cl. 715/782; 715/837; 715/804; 707/E17.044

(57) ABSTRACT

The invention relates to a method for navigating among media files in a mobile communication device. The method comprise assigning at least two features of at least two media files a graphical representation, wherein the graphical representation of the features enables said features to be comparable to each other, displaying the graphical representations on a display, and enabling navigation between the features on the display.

### TECHNICAL FIELD

The present invention relates to the field of portable electronic devices and, in particularly, to an invention which facilitates navigation amongst media files in portable communication devices. The present invention especially targets the area of portable mobile communication devices, such as mobile phones, where new ways of navigating amongst files are highly sought for.

### BACKGROUND

In today's society almost everybody owns and uses a mobile communication device, such as a mobile phone. During the last decade the mobile phone has evolved from being a bulky device only used for making phone calls with, to be a fully fletched entertainment device capable of playing all sorts of media files.

Due to the large storage capacities of today's mobile phones, a user might have several hundreds, or even thousands, of different media files stored in the phone. Traditionally, these media files are categorized and stored in separate hierarchical file structures primarily based on type of media file (e.g. music, movie, picture, text, etc.) and file name. For example, a media folder may contain a picture folder housing all pictures, a music folder housing all music files, etc., and in each such folder the files may be sorted in further folders based on their names, or other feature such as artist, genre, album for music files, and friends pictures, holiday pictures, animal pictures, etc, for picture files. In this way a large hierarchical tree-structure is constructed which may be very difficult and tedious to navigate (requiring several scroll, select, and back operations), and also does not provide any overall sense of ones collection of media files. Therefore, finding a new way of presenting and relating media files to each other in a way that facilitates the navigating amongst them, and also increases the users “bird eyes view” of his or hers collection of media files, is highly sought for.

### SUMMARY OF THE INVENTION

With the above description in mind, then, an aspect of the present invention is to provide a way of presenting and navigating a large collection of media files which seeks to mitigate, alleviate, or eliminate one or more of the above-identified deficiencies in the art and disadvantages singly or in any combination.

As will be described in more detail by the aspects of the present invention below, one way to provide such a way of presenting and navigating in a large collection of media files is to group media files, based on one or more common features, and to display them according to the grouping in one or several easy to navigate media spaces.

A first aspect of the present invention relates to a method for navigating among media files in a mobile communication device, comprising assigning at least two features of at least two media files a graphical representation, wherein said graphical representation of the features enables said features to be comparable to each other, displaying said graphical representations on a display, and enabling navigation between said features on said display.

The method may further comprise grouping of said media files based on features of said media files, and assigning a graphical representation to said group.

The method may further comprise distributing said graphical representations on a displayable imaginary surface, wherein the displaying involves displaying a part of said displayable imaginary surface.

The method may further comprise that said graphical representations are distributed among at least two imaginary surfaces and navigation among said imaginary surfaces is enabled.

The method may further comprise that said displaying involves displaying of graphical representations distributed among at least two imaginary surfaces.

The method may further comprise that said features of said media file is any of the group, a user-assigned parameter, rating, the number of times it has been accessed, or metadata of said media file.

The method may further comprise that said graphical representations of said media files is displayed on the display as computer graphics having size, shape, color, and distance to other graphical representations of said media files.

The method may further comprise that the distribution is based on the features of the media file.

The method may further comprise that said graphical representations sharing at least one common feature are distributed close together on said imaginary surface.

The method may further comprise that the distribution of said graphical representations on said at least two imaginary surfaces and said navigation among said imaginary surfaces is conducted in a three-dimensional representation.

A second aspect of the present invention relates to a mobile communication device comprising assigning means adapted to assigning a graphical representation to a feature of a media file, a display adapted to display the graphical representation of at least two features of at least two media files on the display, and navigation means adapted for navigating among said at least two features of at least two media files on the display. Any of the features in the first and second aspect of the present invention above may be combined in any way possible.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows the front side of a portable communication device, in this case a mobile phone; and

FIG. 2 shows the front side of another portable communication device, in this case a mobile phone with a navigation wheel; and

FIG. 3 shows an example of a media space with media files and/or collection of media files shown as circles; and

FIG. 4 shows how a media space with media files and/or collection of media files represented by circles are navigated using a navigation wheel; and

FIG. 5 illustrates how the display area of a mobile phone showing a media space with media files changes when navigated by the user; and

FIG. 6 shows an example of a 3 level multi media space with associated media files and/or collection of media files; and

FIG. 7 shows an example of how to navigate in and between multi media spaces; and

FIG. 8 shows an example of a display area in a mobile phone when playing audio tracks; and

FIG. 9 shows an example of how a the display area in a mobile phone showing audio tracks may be navigated using a navigation wheel; and

FIG. 10 shows an example of how multimedia files such as audio tracks may be arranged in a media space and displayed in a display area of a mobile phone; and

FIG. 11 shows an example of how multimedia files such as audio tracks may be arranged in a media space and displayed in a display area of a mobile phone; and

FIG. 12 shows an example of how multimedia files such as audio tracks may be arranged in a media space and displayed in a display of a mobile phone; and

FIG. 13 shows an example of how multimedia files such as audio tracks may be arranged in a media space and displayed in a display area of a mobile phone; and

FIG. 14 shows an example of how multimedia files such as audio tracks may be arranged in a media space and displayed in a display area of a mobile phone; and

FIG. 15 shows an example of how multimedia files such as audio tracks may be arranged in a media space and displayed in a display area of a mobile phone; and

FIG. 16 shows an example of how multimedia files such as audio tracks may be arranged in a media space and displayed in a display area of a mobile phone; and

FIG. 17 illustrates how different types of media files with common features may be arranged in different media spaces.

### DETAILED DESCRIPTION

Embodiments of the present invention relate, in general, to the field of portable communication devices and, in particularly, to navigation of media files in such devices.

A preferred embodiment relates to a portable communication device, such as a mobile phone, including navigation means such as for instance a navigation wheel. However, it should be appreciated that the invention is as such equally applicable to electronic devices which do not include any radio communication capabilities. Examples of such devices may for instance be global positioning system devices, laptops (such as standard, ultraportable, and micro laptops), handheld computers, gaming devices, accessories to mobile phones, keyboards, etc. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

Throughout the application references are made to media files. A media file is a file which contains data belonging one or more of the group; audio data, video data, image data, symbol data (text), and general data (e.g. geological coordinates, Web pages, software, etc.). Each media file may have one or more features associated with it. A feature of a media file may for instance be the type of media file, a user-assigned parameter, rating, the number of times it has been accessed, and/or metadata (data about data) belonging to the media file. Metadata may for instance be title, artist, album, length, genre, mood, owner, information about the beat, year, composer, contributing artist, track number, number of tracks, type of file, coding date of creation, time of creation, focal length, aperture, exposure, geographical location data, name, author, date of publication, subject, a unique identifier, physical dimensions, number of pages, aspect ratio, timing information, time stamps, copyright, copyright protection, data rate, frame height and width, frame rate, folder path, size, attributes, country, and language of the media file. A media file may have only a few of the features described above associated with it. For instance a media file containing audio data, such as music, may have features; music file, title, artist, album, length, genre, information about the beat (e.g. bpm), web link to homepage, year, composer, contributing artist, track number and album art. A photograph may have the features; date and time of creation, focal length, aperture, exposure, geographical location data, and name, while a e-book (symbol data) may have the features; title, author, date of publication, subject, a unique identifier (such an International Standard Book Number), physical dimensions, number of pages, and the language of the text, link to corresponding audio track, and web link to bookstore.

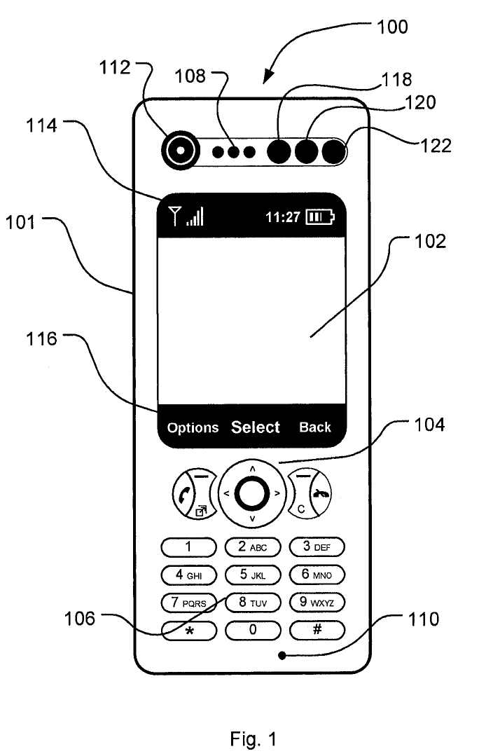

FIG. 1 shows the front side of an ordinary portable communication device, in this case a mobile phone 100, comprising a casing 101, a display area 102, and means 104 for navigating among items (not shown) displayed in the display area. The casing 101 may be made of any type of casing material such as painted or not painted plastic, metal, glass, polymer material, or a combination thereof. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile phone 100 can also comprise other elements normally present in such a device, such as a keypad 106, a speaker 108, a microphone 110, a camera 112, a photo sensor 118 (e.g. ambient light), a infrared light (IR) sensor 120, infrared light emitting diode 122 (IR LED), processing means (not shown), memory means (not shown), one or more accelerometers (not shown), a vibration device (not shown), an AM/FM radio transmitter and receiver (not shown), a digital audio broadcast transmitter and receiver (not shown), a Bluetooth device (not shown), an antenna module (not shown), etc.

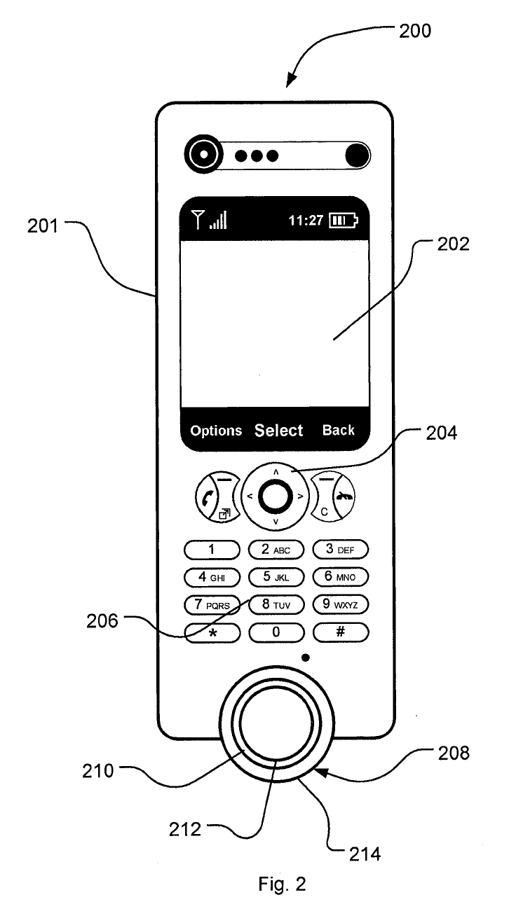

FIG. 2 shows a mobile phone 200, comprising a casing 201, a display area 202, navigation means 204, and a navigation wheel 208 for navigating among items (not shown) displayed in the display area. The mobile phone 200 in FIG. 2 may incorporate all or some of the technical features discussed in conjunction with the mobile phone in FIG. 1. The navigation wheel 208 may be fitted in, or onto, the mobile phone 200 in several different ways. In an embodiment, a part of the navigation wheel 208 may protrude out from the casing 201 (down in the picture), as shown in FIG. 2, while in another embodiment the navigation wheel may not protrude out from the casing 201 of the mobile phone 200.

The navigation wheel 208 may, or may not, be implemented with a hole, indent, or cavity in its centre 216, as shown in FIG. 2. The navigation wheel 208 may, or may not, be implemented to house a device such as a selection button, multi-way navigation button, or a microphone in its centre. In another embodiment the centre just houses a part of the casing.

The navigation wheel itself may be comprised of one or more input sensitive areas which are operable in such way that they allows the user, with his or hers finger(s) or another pen-like object, to navigate among items displayed in the display area 202. In the example shown in FIG. 2 the navigation wheel 208 is comprised of three input sensitive areas or surfaces namely, a front surface 210, a outer surface 214, and an inside surface 212. The input sensitive area, or areas, may cover a part or the whole of these surfaces. In the example shown in FIG. 2, the front surface (the surface facing the reader) has an input sensitive area defined by a circle running all the way around (360°) the front surface of the navigation wheel. In the example shown in FIG. 2, the outer surface (on the outer side of the wheel), which is on the side of the navigation wheel, has an input sensitive area defined by either an arch running from the place where the navigation wheel meets the mobile phones left side casing to where the navigation wheel meets the right side of the casing, or, if the navigation wheel 208 protrudes a little bit from the mobile phone casing 201, completely around the navigation wheel (360°). In the example shown in FIG. 2, the inside surface (on inside of the hole in the wheel) has an input sensitive area defined by the entire inside (360°) side wall 212 of the hole in the navigation wheel. The input sensitive parts may in one embodiment be implemented using movable and/or non-movable mechanical parts, while in another embodiment they may be implemented using movable and/or non-movable electronic parts. In yet another embodiment a combination of electronic and mechanical movable and/or non-movable parts may be used.

The input sensitive areas may be implemented to register movement, pressure (force), light, heat, or vibrations (acceleration). In most cases, the input sensitive areas are implemented to register movement and pressure. In this way the navigation wheel may be used as an ordinary scroll wheel with an integrated button(s). The navigation wheel may also be able to provide feedback to the user in the form of force resistance, vibrations, sound, temperature changes, or nerve stimulation using electricity.

A user of the mobile phone 200 may simultaneously operate one or several of the input sensitive areas on the navigation wheel to perform a certain operation. In one such operation the navigation wheel 208 may be used to scroll items in a list displayed on the screen. For example, if the user moves his or hers finger(s) in a clockwise direction on one (or several) of the input sensitive areas the list will be scrolled in one direction, for instance down or to the right, while if the user moves his or hers finger in an anti-clockwise direction the list will be scrolled in another direction, for instance up or to the left, in the display area 202. The input sensitive areas may also be applied pressure to, for instance be tapped or squeezed, thus act as pressure sensitive selection means, for instance as a button or a multilevel button (registering different levels of pressure applied to it).

Modern-day mobile phones are not only used to make phone calls with, but also used to playing (from hereinafter playing should be interpreted as playback, show, execute, and/or any active operation) a wide range of media files such as music files, movie files, showing picture files, playing audio books, etc. Due to the large storage capacities of modern mobile phones a user may typically fit hundreds and some times thousands of media files of different kind into their mobile phone. Traditionally media files have been categorized due to two factors. One of these factors is the type of media files, for example music files, movie files, text files, etc., while another factor is the names of the media files. The problem with this way of categorizing media files is, as discussed in the background section that we get a large hierarchical tree-structure which may be very difficult and tedious to navigate, and also, which does not provide any overall sense of ones collection of media files. The present invention will in the following figures describe an alternative and much more efficient and intuitive way of displaying, categorizing, and navigating throughout a large collection of different media files stored in a device such as a mobile phone.

In the following figures music media files is going to be used as an example for describing the different aspects of the invention. However, the invention is not in any way limited to the usage of only music media files. The invention works in the same manner with other kinds of media files such as movie files, image files, text files, or any combination thereof.

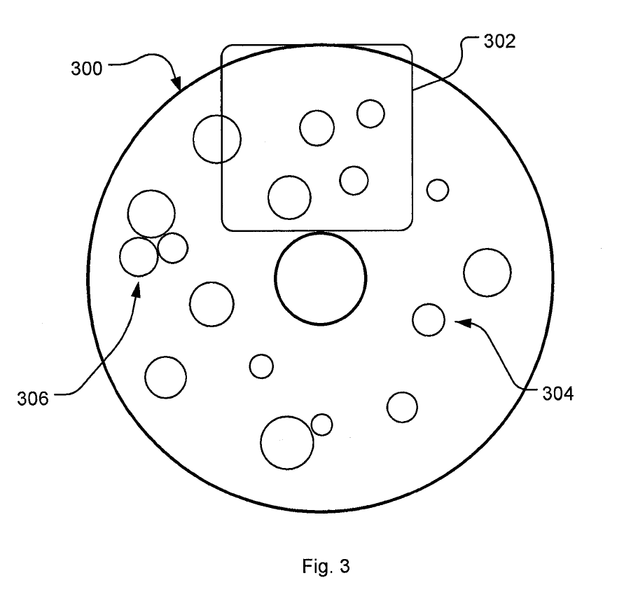

FIG. 3 shows graphical representations, in this case circles 304, of features belonging to a media file or a group of media files, stored in a mobile phone, distributed over a doughnut shaped imaginary surface 300 which from hereinafter is referred to as a media space. In this example, each circle 304 is a graphical representation of a feature of a single media file, such as an audio track of an artist, or a group of media file, such as several audio tracks belonging to an album of an artist. A circle may also represent a group of several different types of media files but with some feature in common, for example an audio track and the corresponding music video and album art. The size of the circle may indicate a comparable feature which allows the user to differentiate the individual circles 304 depending on this feature. In one embodiment the size of the circle 304 may indicate the number of media files present in that particular group, it may indicate some ranking system, such as the number of times played (larger circle=played more times), or it may be an indication based on one or more features connected to the media file(s) metadata (tags).

The distribution of the circles 304 in the media space 300 may indicate a common feature of the media files. For instance, if two media files shares at least one common feature they may be placed close together 306 or in the vicinity of each other. For instance, two albums, represented by two circles, with the same artist may be placed side-by-side in the media space. If for instance the user has got one picture, one album and a music video, all represented by a separate circle in the media space, with the same artist all three circles may be placed close together in media space 300. In this way the user will easily find media files sharing some common feature. In another embodiment the user may be able to easily select by a push of a button alternative views of the media space 300 with different placement criteria. For instance, in one view the graphical representations (the circles) may be placed or distributed in the media space depending on artists while in another view the graphical representations are placed or distributed in the media space by genre, and so on.

To facilitate the navigation, not the whole media space 300 is shown in the display area of a mobile phone at the same time. Only a part of the media space is shown at a given time. In the example in FIG. 3 the square 302 indicates which part of the media space 300 that is available on the display of a mobile phone at that time. The media files may be represented by any graphical figure, such as squares, octagons, triangles or any irregular/regular shape, and are not in any way limited to be presented by a circle only. Also, the features of each media file may be indicated in several different ways. In the example the feature of how many times it was played was indicated by the size of the circle, but it may also be indicated by changing the color or shape, adding animation, adding audio features, etc., to the graphical representation of the media file.

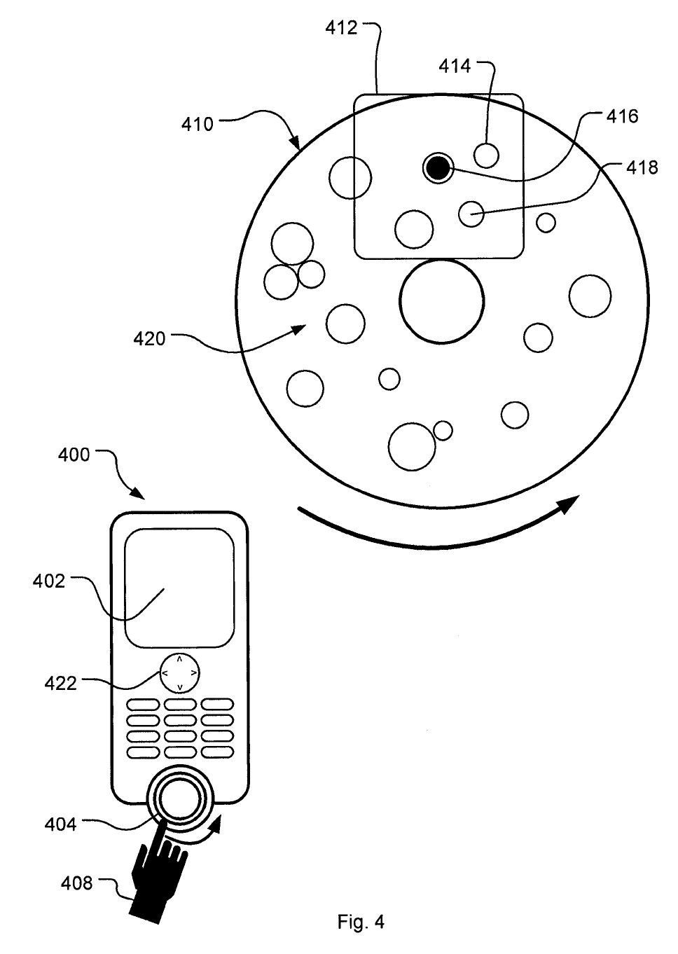

FIG. 4 illustrates how media files 420 in the media space 410, and the media space 410 itself, may be navigated, and also how media files may be selected by a user 408, using a mobile phone 400 with a navigation wheel 404. The circles in the media space 410 represent different media files or collections of media files. The distribution and placement of the media files is due to one or more features associated with each media file or the collection of media files. The size of the media files is due to one or more features associated with each media file, or the collection of media files, not necessary (often not) the same features that was the basis for the placement or distribution of the media files in the media space 410. Not the whole media space is displayed in the display area 402 on the mobile phone 400 at once. The part of the media space 410 which is displayed in the display area 402 on the mobile phone 400 is shown by the square 412 in the media space 410. By having a navigation wheel 404 shaped in the same way as the media space 410 an intuitive navigation environment will be created. When the user 408 performs an anti-clockwise movement on the touch sensitive navigation wheel 404 on the mobile phone 400, the media space 410 will rotate in an anti-clockwise direction as indicated by the arrow in the figure. This rotation will result in that the circles 414,416,418 displayed in the display area 402 of the mobile phone will move to the left in the display area 402, 412. If the user 408 applies a clockwise movement on the touch sensitive navigation wheel 404 the media space will rotate in a clockwise direction resulting in that the circles 414,416,418 representing the media files in the display will move to the right in the display area 402, 412. In this way the whole media space 410 may be navigated using touch movement either in a clockwise or an anti-clockwise direction.

The media file currently situated in the middle (or in any other pre-defined location of the display area) of the display area 412 is indicated in some way, for instance with a black circle 416 as in the example in FIG. 4, to signal that that specific media file is selectable. The user 408 may then select the media file in question by using a select button on the mobile phone or by tapping, pushing, squeezing, the navigation wheel or perform any other selection operation in the mobile phone. In another embodiment the indicated and selectable media file 416 will play a short snipped, for instance 5 seconds of music (if the media file is an audio track), or a display a short text or graphics on the display area indicating the content of the media file. The navigation of the media space 410 is not limited to using only the navigation wheel 404. The media space 410 may be navigated using other navigation means 422 such as buttons, movements of the mobile phone (e.g. shaking it), etc. The media space is not limited to be in a circular or doughnut shape. In another embodiment the media space 410 may be in the shape of a square, a triangle, an octagon or in any other symmetric or un-symmetric shape. However, having a media space shaped in the same manner as the navigation means will make it more intuitive to navigate, thus enhance the usability considerably.

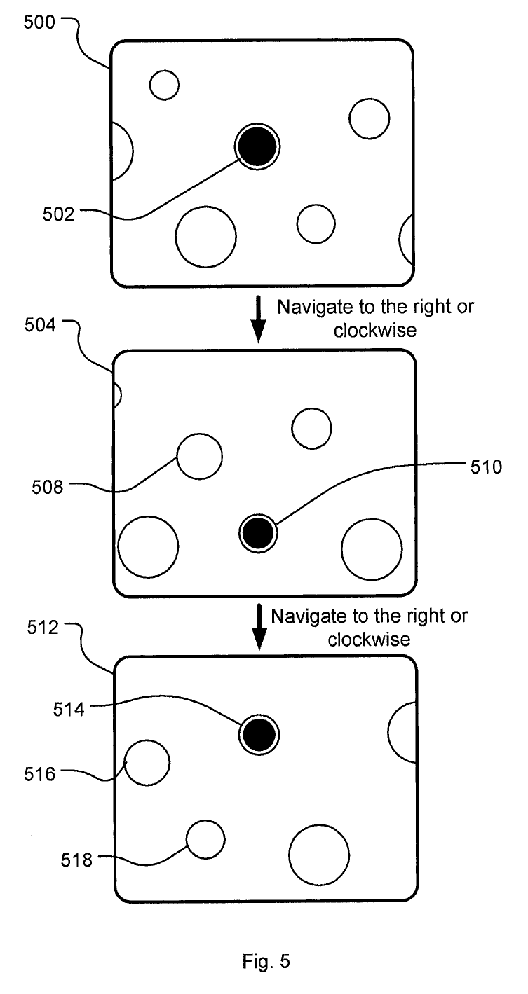

FIG. 5 illustrates, in more detail, what happens in the display area of the mobile phone during navigation as described in conjunction with FIG. 4. The display area 500 at the top of the figure shows how the display area looks before the navigation operation is initiated or begun. In this example the media file 502 situated in the middle or centre (by middle or centre meaning either the centre of the display or the vertical centre of the display) of the display area 500 is automatically indicated (by a black circle) to show that this media file is selectable by a selection operation in the mobile phone. When a clockwise touch movement is performed by the user on the navigation wheel the media files in the display area 500 will move to the left in the display area as shown in the next display area 504. The previously selectable media file 508 has moved away from the centre of the display area and are now not selectable any more (not black anymore). However, a new media file 510 is positioned in the centre of the display area 504 and in this way becomes selectable (indicated by a black circle). Another clockwise touch movement by the user is performed resulting in that the media files will one again move towards the left of the display area resulting in a new formation as shown in display area 512. The previous selectable media files 518, 516 has moved away from the centre of the display and are now not selectable any more (not black anymore). However, a new media file 514 is positioned in the centre of the display and in this way becomes selectable (indicated by a black circle). If an anti-clockwise touch movement had been applied by the user the media space with the circles had moved towards the right side of the display area instead.

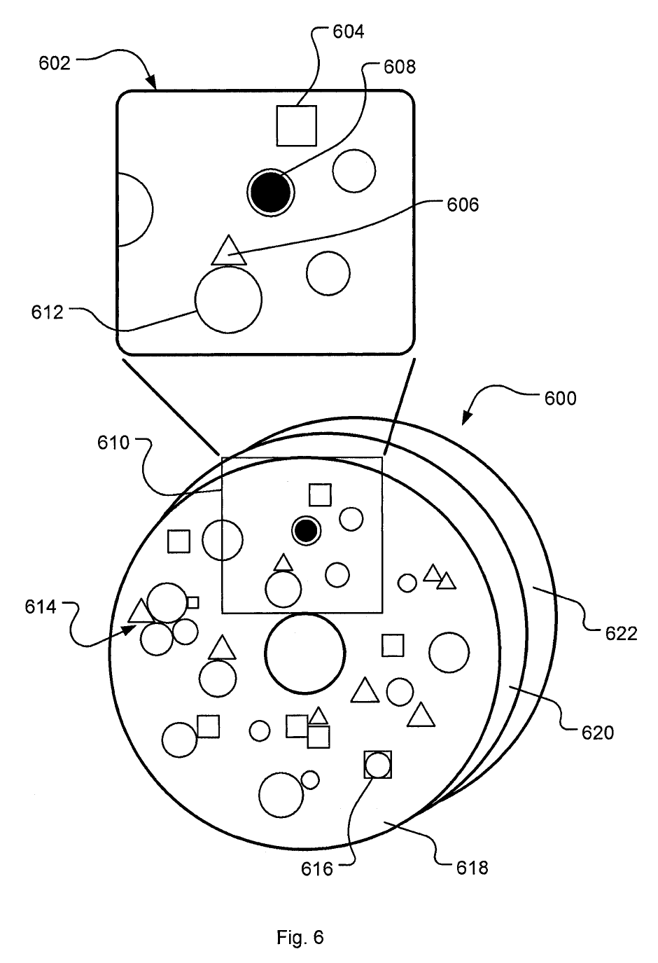

FIG. 6 shows another embodiment of the present invention. In this embodiment several imaginary surfaces or media spaces 600, hereinafter called a media multiverse, each with there own graphical representations of media files present. The example in FIG. 6 shows a media multiverse 600 comprised of three different media spaces 618, 620, 622, wherein the graphical representations belonging to the front media space 618 are indicated by circles, the middle media space 620 by triangles, and the back media space 622 by squares.

In one embodiment the graphical representations belonging to all three media spaces 618, 620, 622, and their interrelation, are shown at the same time in the display area 610, 602 of the mobile phone. The enlarged display area 602 shows an example of the situation where media files from all three media spaces 618, 620, 622 are shown at the same time, wherein graphical representations belonging to the front media space 618 are indicated by circles 612, the middle media space 620 by triangles 606, and the back media space 622 by squares 604. The graphical representation in the middle of the display area 608 is highlighted by a black circle indicating, as in previous embodiments discussed in conjunction with FIG. 3, that it may be selected. In yet another embodiment only graphical representations from a certain (user defined or selected) media space may be shown in the display area.

In one embodiment the all three media spaces moves and acts as a single media space when navigated. In another embodiment the different media spaces will move at different speeds when navigating the media space, giving the impression of having a three-dimensional space of graphical representations in the display view. In yet another embodiment the user may freely navigate between the three-dimensional space by using navigational means. For instance if the user presses a button on the mobile phone the media files represented by circles may disappear giving the impression of that the user has moved past the first front media space and is only looking at the middle and the back media space. In this way the user may freely navigate between the three media spaces selecting media files.

The graphical representations in the different media spaces may be placed or distributed together 614 on the same basis as previously discussed in conjunction with FIG. 3. The different media spaces may in another embodiment represent different storage places in the mobile phone (e.g. internal memory, removable memory, and SIM-card). In another embodiment the different media spaces may belong to different users. For example, a user may have connected to two other friend's mobile communication devices and their media files are shown in the display area in separate media spaces. Overlapping of the grouping 616 may then indicate that two users own the same media file, while similar grouping of graphical representations may indicate that they own media files with one or more common feature. In this way searching a friend's media files and sharing and copying media files with each other will greatly be facilitated.

In another embodiment the different media spaces represents different types of graphical representations of media files. In one embodiment graphical representations of music files will be shown in the front media space as circles, graphical representations of movie files will be shown in the middle media space as triangles and graphical representations of picture files will be shown in the back media space as squares. Overlapping of a circle and a square may then mean that there is an album art to a specific music album, while an overlap of a circle and a triangle may mean that the user has both the audio track and the video of a specific song.

In another embodiment the different media spaces may represent graphical representations of files stored at different points in time, files in different safety backups, files internally and externally stored, etc. The media multivers is also not limited to contain three media spaces. A media multivers may contain everything from two to an infinite number of media spaces.

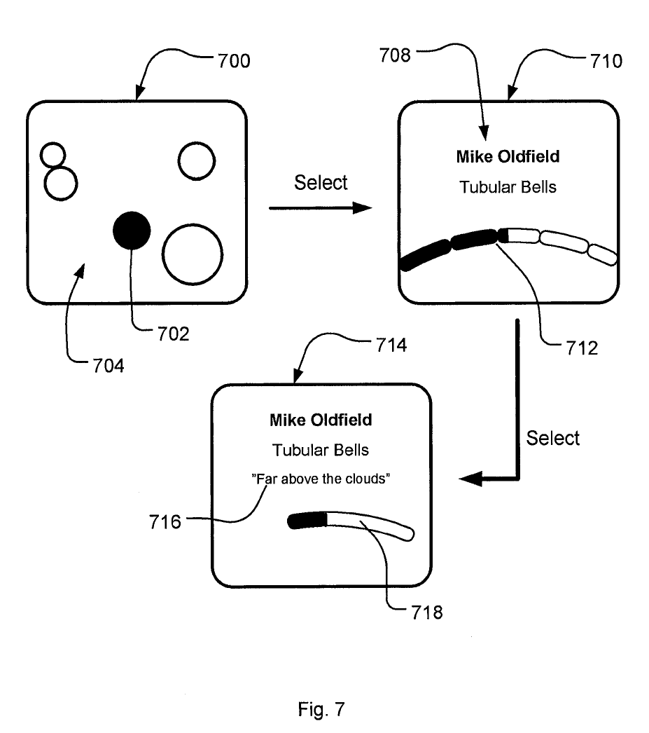

The different media spaces in a media multivers may not group or distribute the graphical representations of media files or collection of media files in the same manner. FIG. 7 shows an example based on graphical representations of music files, of how different media spaces may group and display the graphical representations of media files differently. The display area 700 shows a first media space comprising a collection of graphical representations of media files 704. Each circle in this media space may represent graphical representations of an album of an artist. The middle media file 702 is marked or highlighted black to indicate that the graphical representation of the media file, album, is selectable. In one embodiment a short sequence of the first audio track (or a user-selectable audio track) from the album is played to indicate to the user which album it is. Also, a short text may be displayed describing which artist and album it is, in this example Mike Oldfield with the album Tubular Bells.

When the user selects the indicated graphical representation of the media file 702, the album in this case, a new display view appears 710 showing a new media space in the display area 710 containing the audio tracks 712 of the particular album selected in the previous media space. In the new display area 710 some text information, such as the album title and the name of the artist 708, and elongated squares with round corners 712, hereinafter called ovals, may be shown in the display view 710. Each oval indicates a graphical representation of a media file wherein the length of the oval represents one feature of the graphical representation of the media file, the indication, shown as black in the figure, of the oval represents another feature of the graphical representations of the media file, and the order of the ovals indicates yet another feature of the graphical representation of the media file. In this case each oval represents an audio track on the album and the length of the oval indicates how long each audio track is compared to the other audio tracks on the album. The black indication indicates how much of the audio track that has been played, and if the whole oval is indicated it means that the audio track in question has been played in its entire. If the user selects the audio track being played right now 712, another media space is entered shown by yet another display area 714. In this third media space only one audio from the collection of audio tracks in the second media space and from the album of the first media space is displayed in the display area 714. Except from the from an oval 718 representing the audio track in question additional text 718 may appear stating the name of the audio track played and displayed at the moment in the display area 714. In this way the user may choose if he or she wants to navigate and play audio tracks in a certain way (meaning certain media space). Each media space also gives the user different visual clues, for instance telling him or her how long the audio track is and how much it is left to play, how many tracks that there is in an album and how long the different tracks are in relation to each other, and so on, without cluttering the display with numerals, counters and to much text. In this way the user may focus on and enjoy the music and not the information about the music.

The text 708, 716 displayed in the different display areas shown in the figure may in one embodiment be removed and replaced with an album art or just removed and not showing anything at all.

In an embodiment (most commonly used) the two first display areas 700,710 in FIG. 7 are only implemented. The user then navigates only between the first media space 700 comprising the graphical representations of albums, and the media space 710 containing graphical representations of the audio tracks 712, of the album selected in 700.

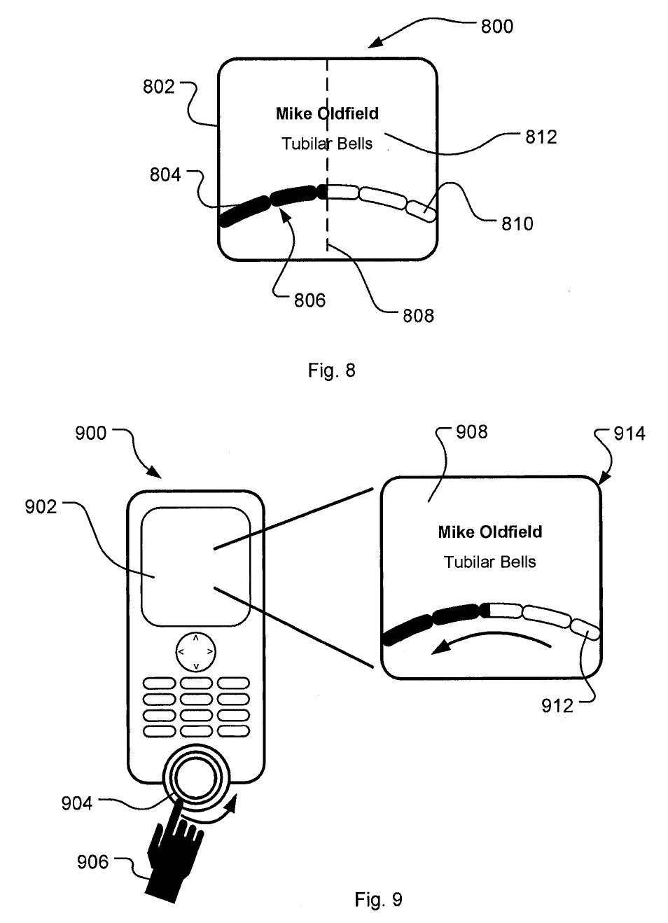

The navigation and selection process of media files in the three media spaces may be exactly the same as discussed in conjunction with FIG. 6 or may different depending on the type of graphical representations of the media files in a particular media space. For example, the first media space may be stationary until navigated with some navigation means, for instance a navigation wheel, while the second media space may continuously be moving in a particular direction in sync with for instance the music played. FIG. 8 shows an example of how a media space may be continuously moving in a display area 800. In this example a user has selected a Mike Oldfield album called Tubular Bells 812, and is right now playing the third audio track on that album. Two audio tracks have already been played, as indicated by the black color of the ovals 804, 806. When the audio tracks are played the whole media space is moved or rotated towards the left edge of the display area 802. The middle of the display area 800, indicated by a dotted line (which does not appear to the user in a real-life situation), is the current point in time , and the part of the display area to the left of the dotted line is the past and the part to the right of the dotted line is the future. When the media space moves from the right to the left in the display view the oval indicating the media file current being played, becomes black when crossing the middle of the screen as shown in the figure. The continuously moving media space may also be controlled and affected by navigation operations coming from the user, as discussed in conjunction with FIG. 9.

If the user 906, as shown in FIG. 9, operates the navigation wheel 906 in a clockwise direction (as indicated by the arrow) the whole moving media space 908 in the display area 914 rotates faster in the clockwise direction (as indicated by the arrow). This will in practice mean that the user fast forwards in the media file currently played. In the same manner if the user operates the navigation wheel 904 in an anti-clockwise direction the media space 908 will move in a anti-clockwise direction (from left to right in the display), which in practice means that the user fast backwards (rewinds) in the currently played media file. If an end or a beginning of an audio track (media file) is reached, the fast forward/backwards continuous in the neighboring audio track. If the last or first audio track (media file) is reached, the fast forward/backwards will in one embodiment result in that the first/last audio track of the next album in the first media space is activated and fast forward/backward in, or in another embodiment that the fast forward/backward operation ends, and we end up with a display area 914 of either in the first or in the second media space, and may navigate from there.

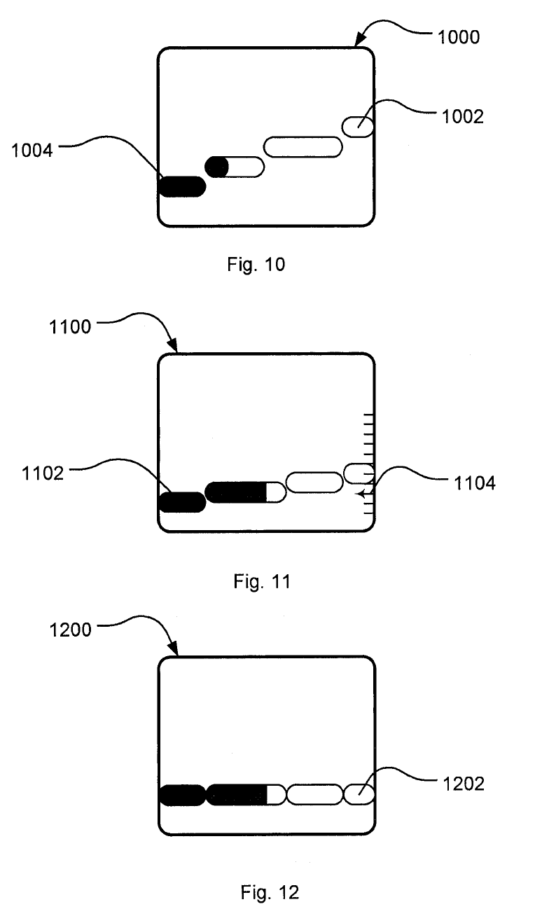

There is several different ways that graphical representations of media files may be presented in a display area, all with their pros and cons. FIGS. 10 to 16 shows a selection of different ways of presenting related graphical representations of media files in a display area. In all display areas the media space moves from the right to the left as discussed above in conjunction with FIG. 9, and also all ovals (or squares) in the figures are graphical representations representing audio tracks in an album.

FIG. 10 shows an embodiment of how graphical representations of media files 1004 related to each other, such as audio tracks in an album, may be displayed in a display area 1000. In this embodiment the ovals 1004 have different lengths depending on a specific feature, such as the length of the media file or more specific the audio track in this example. If the audio track(s) has been activated (has been or being played) it is indicated in black. The ovals will come in from the right 1002 in the display area and disappear to the left of the display area 1000 as times goes by. In this embodiment the ovals are placed in a stir or step configuration which may give visual clues to the user of if we are in the beginning or in the end of an album.

FIG. 11 shows an embodiment of how graphical representations of media files 1102 related to each other, such as audio tracks in an album, may be displayed in a display area 1100. In this embodiment the ovals 1102 have different lengths depending on a specific feature, such as the length of the media file or more specific the audio track in this example. If the audio track(s) has been activated (has been or being played) it is indicated in black. The ovals will come in from the right in the display area and disappear to the left of the display area 1100 as times goes by. In this embodiment the ovals are also placed in a step or stair formation. However, a height scale is placed (but not limited to) in the right edge of the display area 1104. The number of steps on the scale may vary with the number of audio tracks (media files) on an album. The scale will give the user a visual clue as to which audio track currently is playing by indicating on the scale 1104 with an arrow, and also gives the user an visual clue as to of how many audio tracks there are on this particular album (collection of media files).

FIG. 12 shows an embodiment of how graphical representations of media files 1202 related to each other, such as audio tracks in an album, may be displayed in a display area 1200. In this embodiment the ovals 1202 have different lengths depending on a specific feature, such as the length of the media file or more specific the audio track in this example. If the audio track(s) has been activated (has been or being played) it is indicated in black. The ovals will come in from the right in the display area and disappear to the left of the display area 1200 as times goes by. In this embodiment the ovals are also placed in a row allowing for other related information to be shown above or under the audio tracks (media files). This is a display area conservative solution.

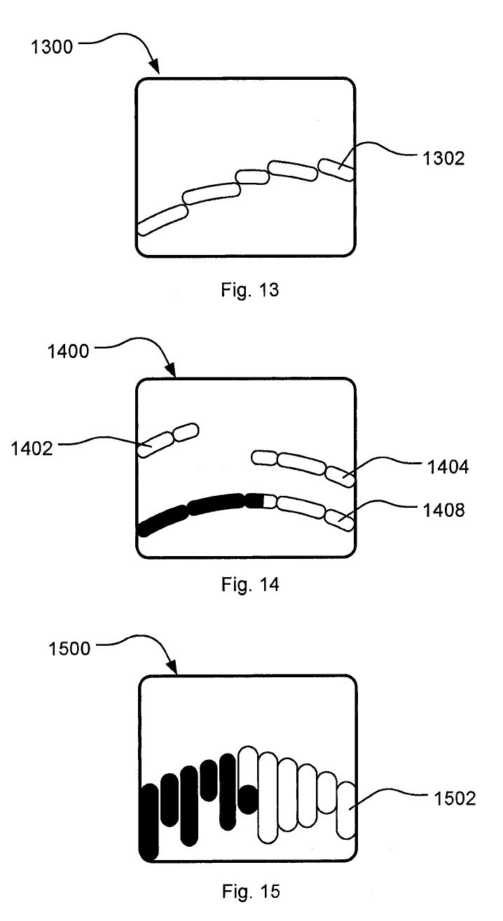

FIG. 13 shows an embodiment of how graphical representations of media files 1302 related to each other, such as audio tracks in an album, may be displayed in a display area 1300. In this embodiment the ovals 1302 have different lengths depending on a specific feature, such as the length of the media file or more specific the audio track in this example. If the audio track(s) has been activated (has been or being played) it is indicated in black. The ovals will come in from the right in the display area and disappear to the left of the display area 1300 as times goes by. In this embodiment the ovals are also placed in a stair or step configuration. The slanted way of displaying the media files will give an indication to the user that the media space in question may be navigated using a navigation wheel, as discussed in conjunction with FIGS. 2 and 4.

FIG. 14 shows an embodiment of how graphical representations of media files 1402,1404,1408 related to each other, such as audio tracks in an album, may be displayed in a display area 1400. In this embodiment the ovals have different lengths depending on a specific feature, such as the length of the media file or more specific the audio track in this example. If the audio track(s) has been activated (has been or being played) it is indicated in black. The ovals will come in from the right in the display area and disappear to the left of the display area 1400 as times goes by. In this embodiment three different collections, such as audio tracks in an album, are displayed at the same time in the same display area. This may for instance be the audio tracks of three different albums belonging to the same or related artists. In this way the user may easily navigate between the different albums without navigating to the first media space and select another album there.

FIG. 15 shows an embodiment of how graphical representations of media files 1502 related to each other, such as audio tracks in an album, may be displayed in a display area 1500. In this embodiment columns have replaced the ovals. The columns indicating an audio track (media file) has been placed alongside each other and in a slightly curved (upper part of the columns) way. The curvature will give reference to the navigation wheel, while the length of the columns indicates the length of the particular audio track (media file). The columns may either move from the right to the left in the display area 1500 or stay still in display area 1500. If the audio track(s) has been activated (has been or being played) it is indicated in black.

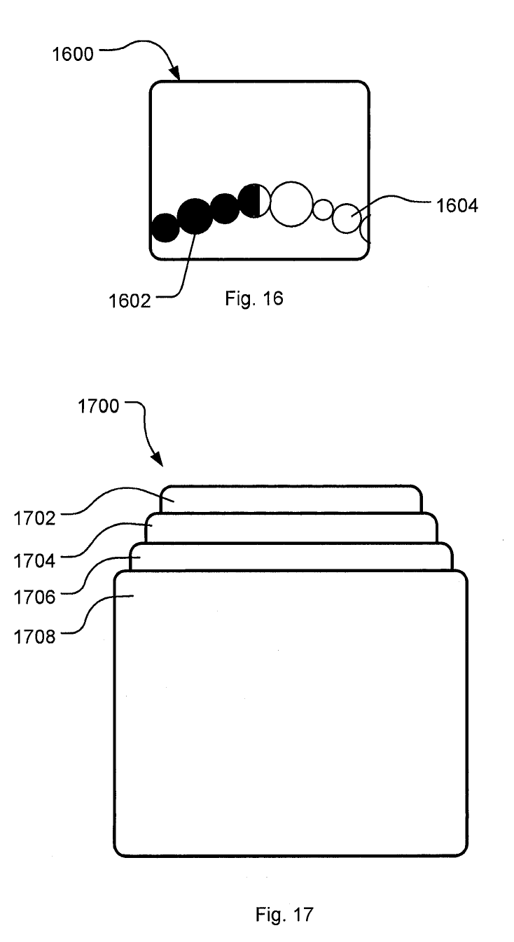

FIG. 16 shows an embodiment of how graphical representations of media files 1602,1604 related to each other, such as audio tracks in an album, may be displayed in a display area 1600. In this embodiment circles 1602,1604 with different sizes are used instead of the ovals. The different sizes may be based on a specific feature, as for instance the number of times the particular track has been played, or a collection of features. The circles are, as in the case of the columns, also placed in a slightly curved way. The curvature will also in this case give reference to the navigation wheel, while the thickness of the circle may also indicate the length of the particular audio track (media file). The filled circles 1602 (black) indicate that the particular audio tracks (media files) have been played.

FIG. 17 illustrates how several display areas 1700 may be perceived to be stacked on top of each other when having a media multivers, as discussed in conjunction with FIG. 6, containing several media spaces. In one embodiment only the top display area 1708 is visible in the display of the mobile phone. The top display area 1708 may for instance display the a graphical representation of an album of an artist, the second display area 1706 may then house a graphical representation of an album art belonging to the album in display area 1708, the third display area 1704 may then house a graphical representation of the lyrics of the tracks belonging to the album in display area 1708, and the fourth display area 1702 may then house a graphical representation of music videos of some of the tracks belonging to the album in display area 1708. When navigating between these media spaces, meaning moving up and down into the stack of display areas 1700 in the figure, the display areas may be transitioned in several different ways. In one way the current display area is enlarged and toned out while the display area behind it goes from being small to normal size. This will give the impression of that the current display area is moving towards the user and that the user passes through the display area ending up at the display area behind the current display area. When navigating back the reverse happens. This will give a three-dimensional feeling to the user when he or she is navigating between the media spaces 1702,1704,1705,1708 in the media multivers 1700. In another embodiment graphical representations in one display area made visible in another display area. For example, if a graphical representation of a track playing is shown in the top display area 1708 the user may, by for instance pushing a button, make an graphical representation of an album art currently in the second display area 1706 be shown in the top display area 1708 by toning it in to the top display area 1708, or by making a part of the top display area transparent, so that graphical representations in the second display area 1706 may appear in the top display area 1708. The navigation between the different display areas (parts of media spaces) in a media multivers may be done in many different ways and are not in any way limited to the ways described in the example above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method for navigating among media files in a mobile communication device, comprising:
assigning at least two features of at least two media files a graphical representation,
wherein said graphical representation of the features enables said features to be comparable to each other;
displaying said graphical representations on a display; and
enabling navigation between said features on said display.

2. The method according to claim 1, further comprising grouping of said media files based on features of said media files, and assigning a graphical representation to said group.

3. The method according to claim 1, further comprising distributing said graphical representations on a displayable imaginary surface, wherein the displaying involves displaying a part of said displayable imaginary surface.

4. The method according to claim 1, wherein said graphical representations are distributed among at least two imaginary surfaces and navigation among said imaginary surfaces is enabled.

5. The method according to claim 4, wherein said displaying involves displaying of graphical representations distributed among at least two imaginary surfaces.

6. The method according to claim 1, wherein said features of said media file is any of the group; a user-assigned parameter, rating, the number of times it has been accessed, or metadata of said media file.

7. The method according to claim 1, wherein said graphical representations of said media files is displayed on the display as computer graphics having size, shape, color, and distance to other graphical representations of said media files.

8. The method according to claim 1, wherein the distribution is based on the features of the media file.

9. The method according to claim 8, wherein said graphical representations sharing at least one common feature are distributed close together on said imaginary surface.

10. The method according to claim 4, wherein the distribution of said graphical representations on said at least two imaginary surfaces and said navigation among said imaginary surfaces is conducted in a three-dimensional representation.

11. A mobile communication device comprising:
assigning means adapted to assigning a graphical representation to a feature of a media file;
a display adapted to display the graphical representation of at least two features of at least two media files on the display; and
navigation means adapted for navigating among said at least two features of at least two media files on the display.
